(19) United States
(12) Patent Application Publication
(10) Pub. No.: US 2015/0032871 A1
(43) Pub. Date: Jan. 29, 2015

(54) AUTOMATED TRAFFIC ENGINEERING BASED UPON THE USE OF BANDWIDTH AND UNEQUAL COST PATH UTILIZATION

(71) Applicant: Telefonaktiebolaget L M Ericsson (publ), Stockholm (SE)

(72) Inventors: David Ian Allan, San Jose, CA (US); János Farkas, Kecskemet (HU)

(73) Assignee: Telefonaktiebolaget L M Ericsson (publ), Stockholm (SE)

(21) Appl. No.: 14/016,976

(22) Filed: Sep. 3, 2013

Related U.S. Application Data
(60) Provisional application No. 61/857,985, filed on Jul. 24, 2013.

(51) Int. Cl. H04L 12/803

(52) U.S. Cl. CPC H04L 47/125
USPC 709/223

(57) ABSTRACT

A method in a network element improves load distribution in a network that includes the network element. The network element is one of a plurality of network elements in the network each of which implement a common algorithm tie-breaking process as part of a computation used to produce minimum cost shortest path trees. The network element includes a database to store the topology of the network. A set of service attachment points is mapped to network elements in the topology for services individually associated with an equal cost tree (ECT) set and associated with per service bandwidth requirements. The topology of the network includes a plurality of network elements and links between the network elements. The method generates multiple ECT tree sets for connectivity establishment and maintenance of the connectivity in the network. The method defines a bandwidth aware path selection. The method reduces the coefficient of variation of link load across the entire network.

### CROSS-REFERENCE TO RELATED APPLICATION

The present application claims priority from U.S. Provisional Patent Application No. 61/857,985 filed Jul. 24, 2013. Cross-reference is made to co-pending patent applications by David Ian Allan and Scott Andrew Mansfield for application Ser. No. 12/877,826 and application Ser. No. 12/877,830 filed on Sep. 8, 2010 and commonly owned. The cross-referenced applications are incorporated herein by reference.

### FIELD OF THE INVENTION

The embodiments of the invention relate to a method and apparatus for improving load distribution in a network. Specifically, the embodiments of the invention relate to a method for load distribution in networks with multiple potential paths between nodes in the network.

### BACKGROUND

Load distribution or load spreading is a method by which breadth of connectivity is more effectively utilized and overall performance is improved in a network. Most automated load distribution and load spreading techniques deployed today, especially those in networks with a distributed control plane, operate with only a very local view, whereby these load distribution and load spreading techniques only consider the number of paths or the next hops to a given destination and do not consider the overall distribution of traffic in the network.

Equal cost multi-path (ECMP) is a common strategy for load spreading of unicast traffic in routed networks that is utilized where the decision as to how to forward a packet to a given destination can resolve to any one of multiple “equal cost” paths, which have been determined to be tied for being the shortest path when running calculations on a topology database. ECMP can be used in conjunction with most unicast routing protocols and nodes equipped with the required supporting data plane hardware, since it relies on a per hop decision that is local to a single router and assumes promiscuous receipt and forwarding of frames combined with a complete forwarding table at every intermediate node. Using ECMP at any given node in a network, the load is divided pseudo-evenly across the set of equal cost next hops. This process is implemented independently at each hop of the network where more than one next hop to a given destination exists.

In many implementations, when the presence of multiple equal cost next hops is encountered, each packet is inspected for a source of entropy such as an Internet Protocol (IP) header and a hash of header information modulo the number of equal cost next hops is used to select the next hop on which to forward the particular packet. For highly aggregated traffic, this method will on average distribute the load evenly in regular topologies (i.e., symmetric topologies) and does offer some improvement in less regular topologies.

### SUMMARY

A method in a network element is described for improved load distribution in a network that includes the network element. The network element is one of a plurality of network elements in the network each of which implement a common algorithm tie-breaking process as part of a computation used to produce minimum cost shortest path trees. The network element includes a database to store the topology of the network. A set of service attachment points is mapped to network elements in the topology for services individually associated with an equal cost tree (ECT) set and associated with per service bandwidth requirements. The topology of the network includes a plurality of network elements and links between the network elements. The method generates multiple ECT tree sets for connectivity establishment and maintenance of the connectivity in the network. The method defines a bandwidth aware path selection. The method reduces the coefficient of variation of link load across the entire network. The method includes a set of steps including determining a set of equal cost shortest paths between each network element pair based upon the topology of the network. Further steps include, checking whether a tie exists between multiple equal cost shortest paths from the set of equal cost shortest paths, applying the common algorithm tie-breaking process where the tie exists between multiple equal costs shortest paths, determining a link bandwidth utilization value and a link available bandwidth value for each link of the network, selecting a network element pair associated with an ECT to be added to the network that have attachment points to a common service instance that has been assigned to that ECT set, and determining a set of candidate paths between the network element pair. A path identifier is generated for each candidate path, where the path identifier is constructed from link available bandwidth values lexicographically sorted from lowest value to highest value. Candidate shortest paths are ranked by link available bandwidth of path identifier. A check is made whether a tie exists between highest ranked candidate paths by path identifiers. A highest ranked candidate path by path identifier is stored in the forwarding database where no tie exists between highest ranked candidate paths by path identifiers, and the common algorithm tie breaking process is applied to highest ranked candidate paths by path identifier where the tie exists between highest ranked candidate paths by path identifiers.

A network element is also described for improved load distribution in a network that includes the network element. The network element is one of a plurality of network elements in the network each of which implement a common algorithm tie-breaking process as part of a computation used to produce minimum cost shortest path trees. A topology of the network includes a plurality of network elements and links between the network elements. The network element implements a method defining a bandwidth aware path selection, the network element implementing the method reduces the coefficient of variation of link load across the entire network. The network element comprises a topology database to store link information for each link in the network. A set of service attachment points is mapped to network elements in the topology for services individually associated with an equal cost tree (ECT) set and associated with per service bandwidth requirements. A forwarding database stores forwarding information for each port of the network element, wherein the forwarding database indicates where to forward traffic incoming to the network element. A control processor is coupled to the topology database and the forwarding database. The control processor is configured to process data traffic, wherein the control processor executes a shortest path search module, a sorting module, and a load distribution module. The shortest path search module is configured to determine a set of equal cost shortest paths between each network element pair using the topology of the network wherein the shortest path search module is configured to determine a set of candidate paths between each of the network element pairs and to send the set of equal cost shortest paths to the sorting module. The sorting module is configured to generate a path identifier for each candidate path, where the path identifier is constructed from link available bandwidth values lexicographically sorted from lowest value to highest value and to send the path identifier for each candidate path to the load distribution module. The load distribution module is configured to rank each of the set of candidate paths based on the path identifiers, to check whether a tie exists between highest ranked candidate paths by path identifiers, to store a highest ranked candidate path by path identifier in the forwarding database where no tie exists between highest ranked candidate paths by path identifiers, and to apply the common algorithm tie breaking process to highest ranked candidate paths by path identifier where the tie exists between highest ranked candidate paths by path identifiers.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 is a diagram of an example of a network topology.

FIG. 2A is a diagram of one embodiment of a network element implementing a load distribution process including automatic traffic engineering as described herein below.

FIG. 2B is a diagram of another embodiment implementing the load distribution process including automatic traffic engineering in a split-architecture as described herein below.

FIG. 3A is a flowchart of one embodiment of the load distribution process including automated traffic engineering that incorporates the use of link bandwidth utilization as feedback into a path selection mechanism.

FIG. 3B is a flow chart of one embodiment of the process for determining the link bandwidth utilization values.

FIG. 4 is a diagram of an example of a multi-point to multi-point network topology.

FIG. 5 is a diagram of another example of a multi-point to multi-point network topology.

FIG. 6 is a diagram of a further example of an asymmetric multi-point to multi-point network topology.

FIG. 7 is a diagram of one example embodiment applying the bandwidth aware computation to an example topology.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

The operations of the flow diagrams will be described with reference to the exemplary embodiment of the figures. However, it should be understood that the operations of the flow diagrams can be performed by embodiments of the invention other than those discussed with reference to the figures, and the embodiments discussed with reference to the figures can perform operations different than those discussed with reference to the flow diagrams of the figures. Some of the figures provide example topologies and scenarios that illustrate the implementation of the principles and structures of the other figures.

The techniques shown in the figures can be implemented using code and data stored and executed on one or more electronic devices (e.g., an end station, a network element, etc.). Such electronic devices store and communicate (internally and/or with other electronic devices over a network) code and data using non-transitory machine-readable or computer-readable media, such as non-transitory machine-readable or computer-readable storage media (e.g., magnetic disks; optical disks; random access memory; read only memory; flash memory devices; and phase-change memory). In addition, such electronic devices typically include a set of one or more processors coupled to one or more other components, such as one or more storage devices, user input/output devices (e.g., a keyboard, a touch screen, and a display), and network connections. The coupling of the set of processors and other components is typically through one or more busses and bridges (also termed as bus controllers). The storage devices represent one or more non-transitory machine-readable or computer-readable storage media and non-transitory machine-readable or computer-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware.

As used herein, a network element (e.g., a router, switch, bridge, etc.) is a piece of networking equipment, including hardware and software, that communicatively interconnects other equipment on the network (e.g., other network elements, end stations, etc.). Some network elements are “multiple services network elements” that provide support for multiple networking functions (e.g., routing, bridging, switching, Layer 2 aggregation, session border control, multicasting, and/or subscriber management), and/or provide support for multiple application services (e.g., data, voice, and video). Subscriber end stations (e.g., servers, workstations, laptops, palm tops, mobile phones, smart phones, multimedia phones, Voice Over Internet Protocol (VOIP) phones, portable media players, GPS units, gaming systems, set-top boxes (STBs), etc.) access content/services provided over the Internet and/or content/services provided on virtual private networks (VPNs) overlaid on the Internet. The content and services are typically provided by one or more end stations (e.g., server end stations) belonging to a service or content provider or end stations participating in a peer to peer service, and may include public web pages (free content, store fronts, search services, etc.), private web pages (e.g., username/password accessed web pages providing email services, etc.), corporate networks over VPNs, IPTV, etc. Typically, subscriber end stations are coupled (e.g., through customer premise equipment coupled to an access network (wired or wirelessly) to edge network elements, which are coupled (e.g., through one or more core network elements to other edge network elements) to other end stations (e.g., server end stations).

As used herein, a packet network is designed to be interconnected by a plurality of sets of shortest path trees where each set offers full connectivity between all network elements in the network or between a specific subset of network elements that share attachment points to common service instances.

Connectivity service instances in the form of virtual networks are supported by the network and typically have service attachment points on an arbitrary subset of the of the network elements. These connectivity service instances are individually assigned to a specific shortest path tree set in the plurality of shortest path tree sets in the network, and utilize the necessary subset of the connectivity offered by the shortest path tree set to interconnect all service attachment points for that service instance.

Ethernet and 802.1aq

The Institute of Electrical and Electronics Engineers (IEEE) 802.1aq standard for shortest path bridging (SPB) is used to construct full mesh shortest path connectivity in an Ethernet network architecture. SPB consolidates what normally is a number of control protocols into a single link state routing system supported by the intermediate system to intermediate system (IS-IS) protocol. This system is used for the computation of integrated and congruent unicast and multi-cast forwarding to construct Ethernet LAN connectivity.

802.1aq is an exemplar of a networking technology that can use edge based load assignment onto one of any number of set of trees and supports multiple connectivity service instances. As such the network can be meshed multiple times.

Ethernet network architectures including those supporting 802.1aq do not support per hop multi-path forwarding. This lack of support is a consequence of the need for congruence between unicast and multicast traffic and because multicast is not compatible with ECMP. Instead, multi-path solutions are implemented by instantiating a separate VLAN for each path permutation and assigning to each of the VLANs a portion of the load at the ingress to the Ethernet network. In the current 802.1aq specification, path permutations are generated via shortest path computation combined with the algorithmic manipulation of the node identifiers which are used for tie-breaking between the equal cost paths. The standardized algorithmic manipulation of node identifiers produces pseudo-random path selection and requires a significant dilation factor (needed to create more virtual paths than there are actual physical paths through the network) in order to even out the link utilization. Overall performance of the current multi-path solution is similar to ECMP.

MPLS

Multiprotocol label switching (MPLS) is a combination of a data plane and control plane technology utilized to forward traffic over a network. MPLS uses per hop labels that are assigned to a stream of traffic to forward the traffic across the network using label lookup and translation (referred to as “swapping”). Each node of the network supports MPLS by reviewing incoming traffic received over the network and forwarding that traffic based on its label, the label is typically translated or “swapped” at each hop.

MPLS networks can improve the distribution of routed traffic in the network using per hop ECMP to distribute or spread a load across equal cost paths. In MPLS networks, a label switch path (LSP) is set up to each next hop for each equal cost path by every node in the network. The forwarding path for a given destination in the network is calculated using a shortest path first (SPF) algorithm at each node in the network, mapped to the local label bindings in the node, and the resultant connectivity appears as a multi-point to multi-point mesh. Individual nodes when presented with traffic destined for multiple equal costs paths utilize payload information as part of the path selection mechanism in order to maximize the evenness of flow distribution across the set of paths. The establishment of the multi-point to multi-point LSP is automated.

The label distribution protocol (LDP) or similar protocol is used to overprovision a complete set of label bindings for all possible forwarding equivalence classes in the network, and then each label switch router (LSR) independently computes the set of next hops for each forwarding equivalence class and selects which label bindings it will actually use at any given moment. MPLS does not have a dataplane construct analogous to the Ethernet VLAN. However, as described in U.S. patent application Ser. No. 12/877,826, this notion can be encoded in the control plane such that MPLS can also have a mode of operation analogous to multi-tree instead of ECMP.

Basic Load Distribution Process Tie-Breaking

The basic load distribution process for the creation of forwarding trees standardized in 802.1aq and applicable to MPLS utilizes a tie-breaking process with distinct properties such that given a set of paths between any two points it will resolve to a single symmetric path regardless of the direction of computing, order of computing or examination of any subset of the path, a property described as “any portion of the shortest path is also the shortest path.” Or stated another way, where a tie occurs along any portion of the shortest path, those nodes will resolve the tie for the subset of the path with the same choice as all nodes examining any other arbitrary subset of the path, the result being a minimum cost shortest path tree. This is referred to herein as the “common algorithm tie-breaking” process. Algebraic manipulation of the inputs into the tie breaking process are used to generate topological variability between the individual sets of trees so computed.

In the basic routing process, some network event will trigger a recomputation of the forwarding tables in the network in order to reconverge the network. This may be in response to a failure of a node or link, addition of components to the network, or some modification to the set of service instances supported by the network. The triggering of recomputation results in an initial pass of the topology database using the link metrics for shortest path determination and utilizing the common algorithm tie-breaking process which results in the generation of the first set of one or more congruent and symmetric trees whereby each will fully mesh all network elements in the network. This in many ways is nearly equivalent to applying bandwidth aware path selection to an unloaded network as no load on any link has been placed; hence, all equal cost/equal capacity paths will be tied for utilization where the definition of equal cost is the lowest metric combined with the lowest number of hops. The initial step requires the determination of the lowest cost paths between each of the node pairs in the network where lowest cost indicates the lowest metrics (i.e., cost in terms of latency or similar end to end (e2e) metric) and where more than one lowest cost path between any two nodes is found (i.e., multiple paths with the same metric), then the number of hops (i.e., shortest physical path) is utilized as an initial tie breaker. If there remains a tie between paths with the lowest metric and the lowest number of hops, then the common algorithm tie-breaking process is utilized in order to generate a unique path selection between each of the node pairs in the network and to ultimately generate a mesh of equal cost forwarding trees, termed an “ECT set” in Institute of Electrical and Electronics Engineers (IEEE) standard 802.1aq and as used herein.

Overview

The embodiments of the present invention provide a system, network and method for avoiding the disadvantages of the prior art including: the first two ECT algorithms documented in 802.1aq will generate two fairly diverse paths when applied to a reasonably meshed network, but do not account for actual offered load to the network and the diversity will diminish as further paths are instantiated using the standardized algorithms. The technique in 802.1aq of masking node IDs with a fixed value to generate new rankings for tie breaking at best produces pseudo random path sets where a larger number of paths is required than the actual potential number of diverse paths in the network in order to guarantee coverage. This provides for an inconsistent spreading of load and is inadequate for more richly meshed networks that support large numbers of virtual private networks (VPNs), such as data centers, as it distributes load on the basis of the combination of topology and the vagaries of node ID assignment. The ability to configure bridge priorities permits this to be mitigated, but the technique can only somewhat optimize a single topology and cannot anticipate the consequences of any failures.

These disadvantages are not limited to load spreading in networks implementing 802.1aq. Other networks including those implementing multi-protocol label switching (MPLS) and similar technologies would have similar limitations. While embodiments herein may refer to 802.1aq and Ethernet shortest path bridging, these embodiments are provided by way of example rather than limitation and one skilled in the art would understand that the embodiments can be applied to other types of networks for improved load spreading.

Other disadvantages include that trying to implement ECMP or per hop load spreading may require significant modifications to the underlying technology base (e.g., Ethernet), which would lose symmetrical congruence of unicast and multicast communication, and negate many of the benefits of supporting technologies (e.g., Ethernet Operations, Administration and Management (OAM)) as the fate sharing and symmetry properties necessary for successful path instrumentation would be violated.

It is possible to consider variations of the algorithms for ECT set generation by considering a sequence of passes through the topology database, whereby the feedback of link utilization modifies the path selection criteria for subsequent computation. This would be a superior approach over algebraic manipulation of the outputs of a single pass as it offers greater subtlety in traffic engineering and the opportunity for significant algorithm improvements.

Such an improved load spreading tie-breaking technique 802.1aq was described in U.S. patent application Ser. No. 12/877,826 (and a similar technique for MPLS is described in U.S. patent application Ser. No. 12/877,830), which reduced the number of path sets required to get good coverage of a network topology but was still based purely upon the topology of the network and assumed all nodes offered equal load on all shortest paths, such that if a network topology had an asymmetric distribution of endpoints or unevenly distributed traffic profile, the data traffic in the network would still not be well balanced.

The embodiments of the invention overcome these disadvantages by augmenting the intermediate system to intermediate system (IS-IS) shortest path bridging (ISIS-SPB) routing system or similar technology (e.g., some other interior gateway protocol (IGP) utilized by some arbitrary networking technology), such that when a source of load associated with a specific community of interest is added to a network in the form of a service instance and a set of service attachment points, the associated traffic parameters are advertised and can be used by the network nodes to ultimately provide additional information to be used as an input to path selection.

A network is configured to use a specified number of ECT sets for forwarding, the order in which to compute them and the algorithm to use for each. Individual service instances are assigned to one of the plurality of ECT sets. The criteria by which such services are assigned to which ECT set is out of the scope of this invention. A bandwidth aware path selection step may be augmented with multiple variations of the common algorithm such that multiple ECT sets can be derived from a single bandwidth aware computation step. For simplicity the remainder of the IVD documents the case whereby a single ECT set is the output of each bandwidth aware path selection process.

When an event occurs requiring recomputation of the ECT sets to reconverge the network, nodes in the network may be configured to perform the initial equal cost tree (ECT) computation on the basis of network topology and metrics as per the standard (although it is noted that it could be a common algorithm for the first and subsequent ECT sets). In other embodiments, other algorithms can be utilized in place of the standard for the generation of the first ECT set. Subsequent ECT set generation may be configured to weight the paths on the basis of available bandwidth metrics using the mapping onto the topology of the cumulative per link bandwidth used by the load sources assigned to previous ECT sets in the computation sequence. So each subsequent ECT set's path placement will select paths that have the most available bandwidth, net of the cumulative path placements to that point in the convergence process. With the embodiments described herein, paths of unequal cost can be considered and utilized as link metrics are not the only criteria considered.

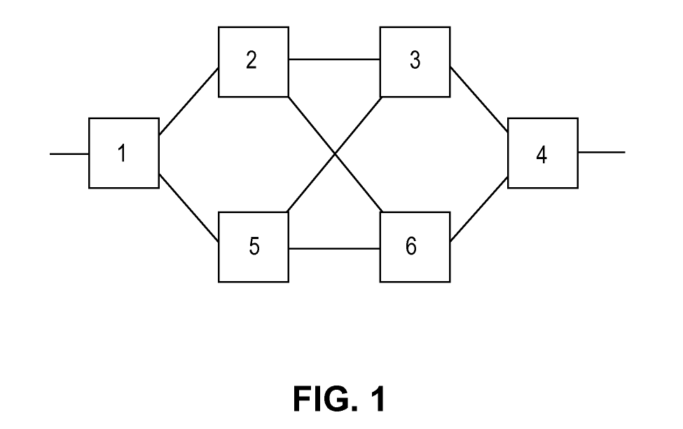

FIG. 1 is a diagram of one embodiment of an example network topology. The example network topology that includes six nodes with corresponding node identifiers 1-6. No path pairs have been determined for the network topology. An example common algorithm tie-breaking process can be utilized that ranks the paths lexicographically using the node identifiers. Examining the set of paths of equal cost (i.e., the e2e metrics are the same and the hop counts are the same) between node 1 and node 4 will generate the following ranked set of path identifiers (note the path identifiers have been lexicographically sorted such that the node identifiers do not appear as a transit list):

1-2-3-4

1-2-4-6

1-3-4-5

1-4-5-6

This initial application of the tie-breaking process will select 1-2-3-4 and 1-4-5-6 as the low and high ranked paths between these nodes. For simplicity in this example, only node pair 1 and 4 is considered in determining the path count for the network rather than the shortest path trees from all 6 nodes.

Using a topology based load distribution and tie-breaking process such as that described in U.S. patent application Ser. No. 12/877,826 and in U.S. patent application Ser. No. 12/877,830, the links in the selected paths would each then assigned with a path pair count of 1 indicating “link utilization.” For the next pass through the topology database the load distribution process would yield the following lexicographic sort of load associated with each of the path IDs.

Load 0,1,1 for path 1-2-4-6

Load 0,1,1 for path 1-3-4-5

Load 1,1,1 for path 1-2-3-4

Load 1,1,1 for path 1-4-5-6

The lexicographic sorting of link loads will result in a tie for paths 1-2-4-6 and 1-3-4-5, as each is 0-1-1. Similarly the sum of link loads will yield:

Load 2 for path 1-2-4-6

Load 2 for path 1-3-4-5

Load 3 for path 1-2-3-4

Load 3 for path 1-4-5-6

As a result for both ranking styles, the secondary tiebreaker (i.e., the common algorithm) of the lexicographically sorted path IDs is employed. In both cases from this secondary tie-breaker the low path (1-2-4-6) is selected. Similarly 1-3-4-5 can be selected as the high ranking path ID of the set of lowest loaded paths. In one embodiment, when low-high selection is utilized, two paths are selected. These paths can be the same or have significant overlap. For example, if the path 1-3-4-5 did not exist in the ranked list above, then the path 1-2-4-6 would qualify as both the low and high ranked paths of lowest cost.

When considering this topology based load distribution example, one of ordinary skill in the art would understand that after a single pass of the database, a comprehensive view of the potential traffic distribution exists and that the tie-breaking of subsequent passes will inherently avoid the maxima and therefore the load is distributed across the network more evenly if it is offered evenly. The degree of modification of load distribution proportionately diminishes with each new set of paths considered as the effect is cumulative if one assumes the sources of load are evenly distributed in the network. As a consequence of needing to consider topology, an “all pairs” computation is required for the generation of each ECT set in order to provide a comprehensive view of path placement for the next ECT set computation.

In the load distribution of the above example, link utilization is represented by the count of pairwise shortest and/or equal cost paths that transited a link. However, this measure of link utilization is not based on the actual or real-world utilization of the links or their capacity. For a network that supports a single large any-to-any community of interest significant improvement in the modeling of traffic by a routing system is difficult, but when the network supports a large number of small communities of interest it becomes possible to utilize numerous variations for representing offered load link utilization such that the expected traffic matrix can be approximated with greater detail and increased accuracy. This is partially a consequence of the fact that when the community of interest includes a small number of endpoints, the dilation/oversubscription considerations become tractable when compared with when the community of interest is a thousand or a million endpoints. As described further herein below, the simplistic count of shortest paths assuming a complete any to any topology is replaced by use of bandwidth information specific to the set of provisioned services and service endpoints. This bandwidth information can be associated with each service identifier registration (I-SID), in the case of 802.1aq. This can be expressed as some augmented form of an SPBM service identifier and unicast address sub-TLV in IS-IS-SPB or through a similar mechanism dependent on the protocol architecture for the network. This bandwidth information enables path selection based on the actual contracted traffic matrix that has been determined to already transit each link as a result of previous path placement steps, rather than simply a count of shortest paths that transit a link. Further, when computing an ECT set, shortest path trees only need to be computed for the nodes that are sources and/or sinks of load for services mapped to that ECT set, and the requisite information for mapping load to topology will still be correct to permit the cumulative per link load to be determined for the computation of subsequent ECT sets.

Thus, in the process of computing the configured number of ECT sets the network is configured to use, as new ECT sets are computed for addition to the network, they explicitly seek the paths with the maximum available bandwidth net of that used by previous ECT sets in the computation sequence. As each ECT set is an aggregate of a number of subtrees each with its own bandwidth requirement resulting in potentially a unique bandwidth requirement per link in the tree, this form of tree computation and tiebreaking best accommodates a difficult to model traffic matrix when compared with a typical constrained shortest path computation whereby all links of insufficient capacity are pruned and a tree of equal bandwidth hops is fitted to the surviving link set. As the described algorithm operates on aggregates, it has the potential to converge the network in near real time.

The initial pass through the database to calculate the first set of ECTs may use the common algorithm and is referred to herein as the “topology aware computation,” while subsequent ECT sets calculated based on the combination of topology and the available bandwidth net of the load placed so far is referred to as “bandwidth aware computation.”

The method also works with the existing Ethernet, MPLS or similar technology base, such that operation, administration and management (OAM) protocols can be utilized unmodified and the technique preserves the architecture and service guarantees of an Ethernet, MPLS or similar network.

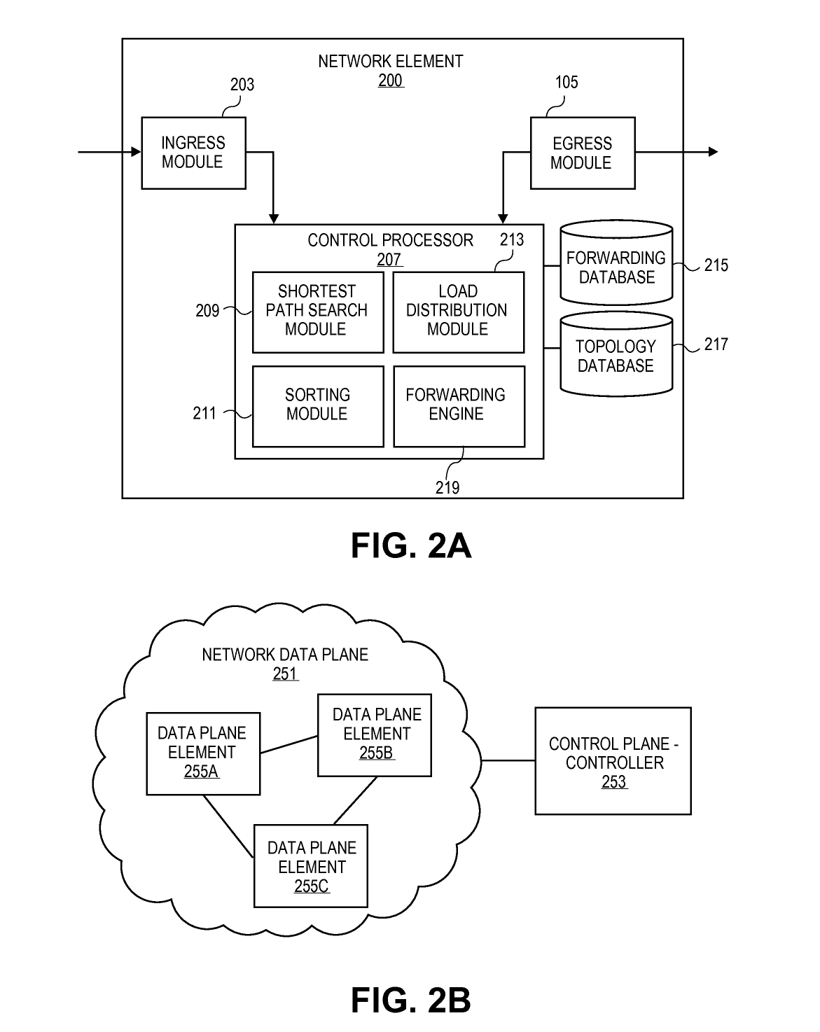

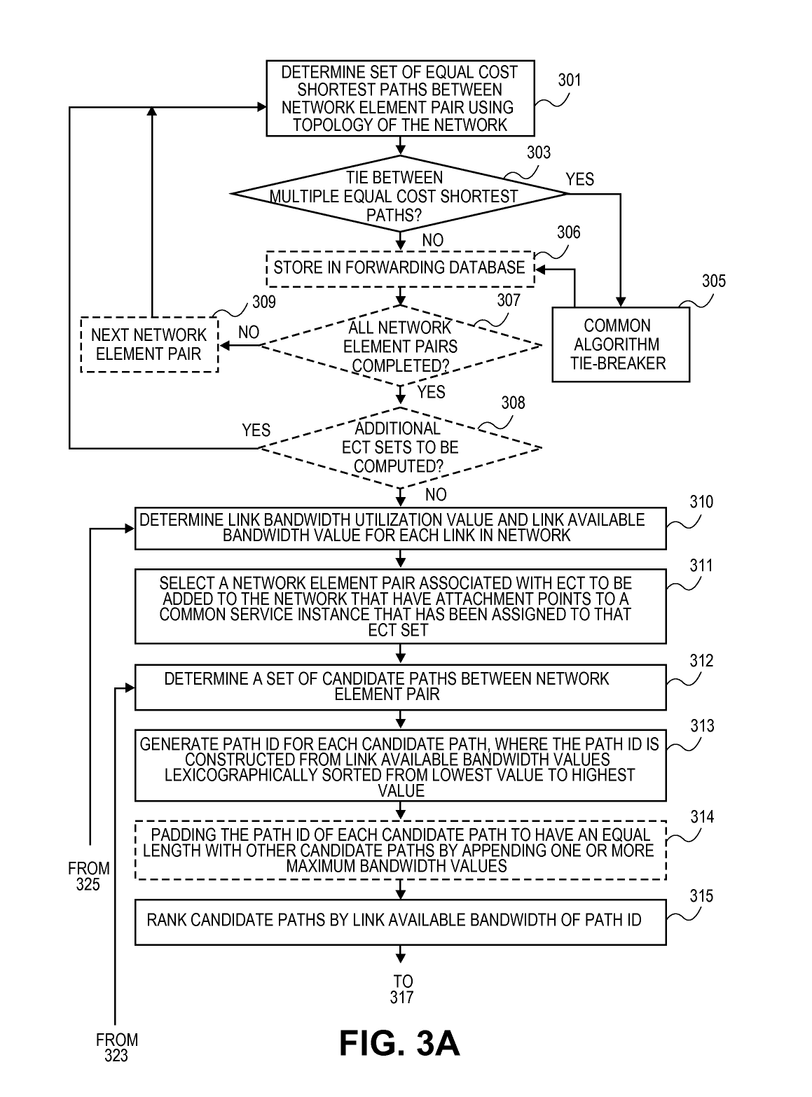

FIG. 2A is a diagram of one embodiment of a network element implementing load distribution process with the bandwidth aware path selection for automated traffic engineering. This load distribution process is based upon the use of link available bandwidth as feedback into the path selection mechanism. In one embodiment, the network element 200 can include a forwarding database 215, a topology database 217, an ingress module 203, an egress module 205, a forwarding engine 219, load distribution module 213, sorting module 211, shortest path search module 209 and a control processor 207. In other embodiments, such as an MPLS implementation other components such as a label information base, LDP module, MPLS management module and similar components can be implemented by the network element 200. The example embodiment of the network element can be an 802.1aq Ethernet bridge, however, one skilled in the art would understand that the principles, features and structures can be applied to other architectures such as a network element implementing MPLS.

The ingress module 203 can handle the processing of data packets being received by the network element 200 at the physical link and data link level. In one embodiment, this includes identifying IS-IS traffic destined for the control processor 207. The egress module 205 handles the processing of data packets being transmitted by the network element 200 at the physical link and data link level. The control processor 207 can execute the forwarding engine 219, the shortest path search module 209, load distribution module 213 and sorting module 211.

The forwarding engine 219 handles the forwarding and higher level processing of the data traffic. The forwarding database 215 includes a forwarding table and forwarding entries that define the manner in which data packets are to be forwarded. Forwarding entries relate addresses to network interfaces of the network element 200. This information can be utilized by the forwarding engine 219 to determine how a data packet is to be handled, i.e., which network interface the data packet should be forward unto. The load distribution module 213 creates forwarding entries that implement the load distribution as described herein below.

The topology database 217 stores a network model or similar representation of the topology of the network with which the network element 200 is connected. The topology database 217 includes identifiers for each of the nodes in the network as well as information on each of the links between the nodes. In one embodiment, the nodes in the network are each network elements (e.g., Ethernet bridges or similar devices) and the links between the network elements can be any communication medium (e.g., Ethernet links). The nodes (i.e., each network element) can be identified with unique node identifiers and the links with node-identifier pairs. One skilled in the art would understand that this network model representation is provided by way of example and that other representations of the network topology can be utilized with the load distribution method and system.

A shortest path search module 209 is a component of the control processor 207 or a module executed by the control processor 207. The shortest path search module 209 traverses the topology database 217 to determine a set of candidate paths between any two nodes in the network topology. If there are multiple paths meeting the required criteria, for example, having an equal distance or cost (i.e., lowest e2e metrics) in the network between two nodes, then this path set can be provided to the sorting module 211 and/or load distribution module 213 to determine which to utilize. The shortest path search module 209 can be used to determine the sets of candidate paths between all node pairs in the network topology or the shortest path search module 209 may restrict the search to all nodes pairs in the network topology that contribute load, e.g., for a particular service that can be identified by an I-SID, both the all nodes and the all load sourcing or sinking node embodiments are referred to herein as an “all pairs” computation.

The shortest path search module 209 provides a set of candidate paths for each node pair considered to the load distribution module 213 and the load distribution module 213 selects a subset of these candidate paths and updates the forwarding database to include a forwarding entry that implements the subset of the selected paths that traverse the network element 200.

After the first pass, and prior to each subsequent pass of bandwidth aware ECT set generation, the load distribution module 213 calculates the link available bandwidth value for each link in the network topology. The link available bandwidth value is a representation of the link bandwidth net of the cumulative bandwidth utilization resulting from all previous ECT set generation steps in the current ECT set recomputation cycle. This relies on bandwidth information for each I-SID associated endpoint attached to the network. The IS-IS information exchanged is augmented to provide a traffic descriptor for each I-SID endpoint attached to the network where the traffic descriptor was populated by management, although in a degenerate case, a default value could be used without requiring changes to add a descriptor to IS-IS, or as an alternative to avoid configuration steps, a descriptor using values derived from the bandwidth of the attachment link could also be used, yet other variations of how this information is obtained are possible. In one example embodiment, a Metro Ethernet Forum (MEF) 10.2 type of descriptor could be utilized to include a committed information rate (CIR_{I-SID}) and burst rate or excess information rate (EIR_{I-SID}). Further in the example embodiment, the value is adjusted to represent the community of interest associated with the I-SID, with this information, a number of pairwise I-SID endpoints is determined that use each link (nₗᵢₙₖ). The total number of endpoints for each I-SID (n_{I-SID}) is determined. A division factor can then be determined to apply to the I-SID traffic descriptors on the assumption that the traffic matrix was evenly divided between the endpoints on average or as is well understood to those skilled in the art, this could be modified to reflect an oversubscription or dilation factor for how traffic is distributed in a multipoint service construct.

A simple but not the exclusive or best form of this computation is presented where for a given ECT set and for each node pair that includes a link on an assigned path between them, the set of I-SIDs in common assigned to that ECT set is determined. For each I-SID endpoint pair in the set, the bandwidth descriptor is adjusted by being divided by the number of I-SID endpoints minus one, and the cumulative results for all I-SIDs in common is summed. The resulting number represents the expected bandwidth consumption on that link for all I-SIDs in that ECT set.

### This Process can be Expressed as Pseudocode as Follows:

For all links in a network
Link_utilization[link]=0
For all ECT sets computed so far

For all nodes pairs in network (or For all node pairs associated with a load or at least one service, i.e., associated with at least one I-SID)

If link on shortest path between node pair in this ECT set
For all I-SIDs assigned to this ECT set that the node pair have in common

Link_utilization[link]+=I-SID bandwidth value/(# of endpoints in I-SID-1) and modified by any dilation or oversubscription factors

When completed, Link available bandwidth[link]=link capacity[link]−link_utilization[link]

The link bandwidth availability value is calculated and recorded for each link. These link bandwidth availability values are utilized when performing bandwidth aware path selection to generate a path available bandwidth value that in turn is used to bias the rankings of the paths for subsequent ECT set generation steps where the initial selection criteria is either the ranked list of lexicographically sorted link bandwidth availability values, and where this results in a tie for both highest available e2e bandwidth and lowest e2e sum of metrics the common algorithm tie-breaking process is used as a subsequent tie breaker. The combination of the two algorithms will produce a unique path selection where any part of the selected path is also congruent with the selected path, a key property for planar forwarding tree generation.

The sorting module 211 is a component of the control processor 207 or a module executed by the control processor 207. The sorting module 211 assists the load distribution module 213 by performing an initial ranking of the loaded set of equal cost trees based on the path available bandwidth values in the second pass and in subsequent passes.

For bandwidth aware path selection, the concept of “equal cost path” is modified to become “path qualification”, as the sum of metrics for each path becomes only one input to selecting a set of paths to which bandwidth aware path selection may be applied. The objective of “path qualification” is to ensure that a useful and bounded set of paths between the points of interest be considered, and the same set or subset when path fragments also embody ties, will be chosen by any nodes computing paths in the network regardless of the direction of computation. An exemplar path qualification algorithm that would produce such a useful candidate set would be to determine the longest path in terms of hops that had the lowest metric or was tied for lowest metric, and then select all paths of an equal or a lower hop count between the source and destination.

For each node pair with multiple candidate paths, the sorting module 211 generates a ranking of each of these candidate paths based on path available bandwidth values and the load distribution module 213 selects at least one path from this ranking. The load distribution module 213 is a component of the control processor 207 or a module executed by the control processor 207.

In one embodiment, when computing the first ECT set (which by definition has to be topology aware), equal cost paths are determined as having equivalence in both the lowest number of hops and the lowest metric. The lowest number of hops needs to be equal for tie-breaking to produce ECTs with the appropriate properties when all aspects of this improved algorithm and the common algorithm are considered. However, for computing bandwidth aware ECT sets, the equivalence of lowest metric requirement can be eliminated and path selection can be performed across the qualified set of paths that may be of unequal length or of higher metric than the shortest path. A given path may have a higher metric, but actually have more available bandwidth that a path of a lower metric as an artifact of the initial topology aware computation and any previously placed ECT sets.

This process can be repeated through any number of passes or iterations where the link available bandwidth values are updated to be a cumulative indication of the bandwidth requirements of the set of service endpoint pair paths that transits it vs. the actual physical link capacity. The path available bandwidth values are also updated in line with the changes to the link utilization values. The number of passes or iterations is designated by an administrator typically at network commissioning time, is configured network wide and the choice is a compromise between efficiency, state and target convergence times for the network.

In other embodiments, the functions for implementing load distribution enabling automated traffic engineering are executed by a control plane or control processor that is remote from a dataplane or forwarding processor. The example illustration and architecture of FIG. 2A can be adapted to such a split architecture as illustrated in FIG. 2B. The shortest path search module 209, load distribution module 213 and sorting module 211 can be executed by a control processor of a controller 253 that is remote from the network elements implementing the forwarding engine in a set of data plane elements 255A-C. The controller can be in communication with the dataplane 251 via a flow control protocol, such as the OpenFlow protocol. The functions of the shortest path search module 209, load distribution module 213 and sorting module 211 can implement the same functionality as described in the illustrated architecture of FIG. 2.

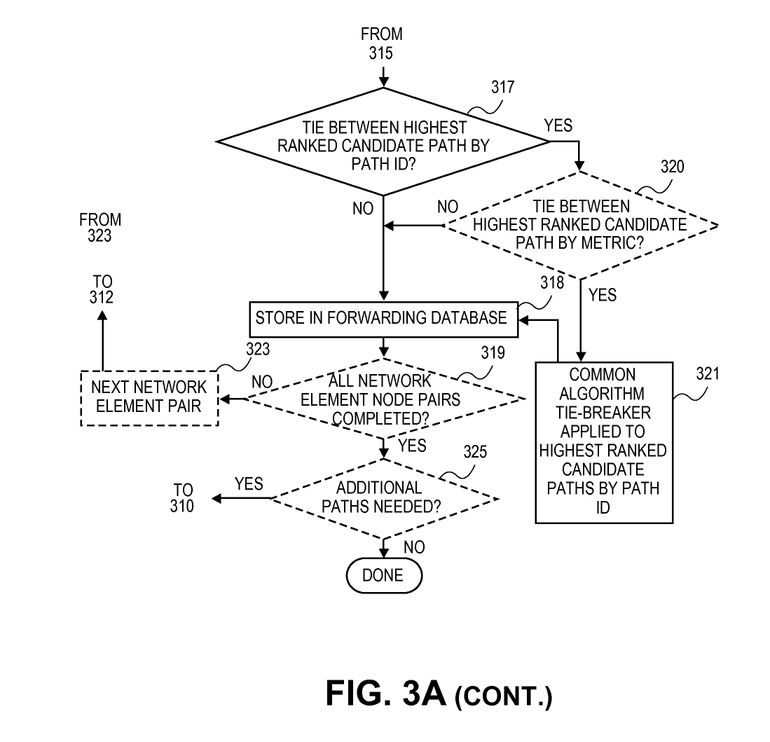

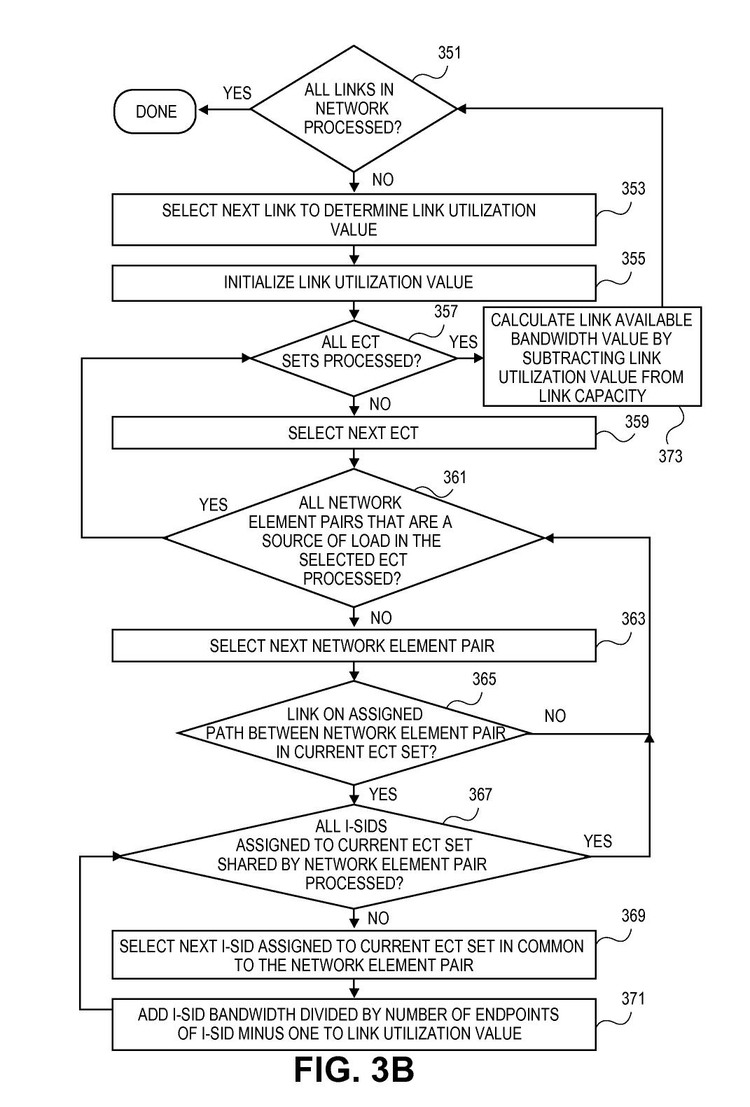

FIG. 3A is a flowchart of one embodiment of a process for load distribution enabling automated traffic engineering based upon the use of link bandwidth utilization as feedback into the path selection mechanism for qualified paths. In one embodiment, the process can be run at the initiation of a network element, for example an Ethernet bridge, upon notification of a change in topology to the network connected to that network element, at defined intervals or at similar events or times. A topology database is maintained at each network element in a network as a separate process from the load distribution process and is assumed to be a current representation of the true topology of the network. The example flowchart discusses the process in terms of network elements and network element pairs, a network element is a node in a network and the term node is used herein above in describing the process, principles and structures and would be understood by those skilled in the art to encompass network elements and similar devices.

In one embodiment, the load distribution process begins by determining the shortest path between a network element in the network and another network element in the network (Block 301). A check is made to determine whether there are multiple equal cost shortest paths, that is, there is a tie for equal cost shortest path between the network element pair (Block 303). If the network element pair has a single lowest cost path (i.e., lowest metric) between them, the forwarding database (or similar data structure such as a label information base) is updated to reflect the lowest cost path (Block 306). In one embodiment, the forwarding database is updated to reflect each of the paths that traverse the network element that maintains it. Each network element in the network performs this same calculation using the same information (which has been synchronized by a combination of ISIS procedures). The load distribution process is deterministic and thus each network element will compute the same result.

If the network element pair does not have a unique lowest cost path measured as the lowest metric or cost then, as mentioned above the number of hops can be considered as a possible tie breaker. If there are multiple equal cost shortest paths (i.e., equal metric and number of hops), then the common algorithm tie-breaking process is used to permit a unique shortest path per equal cost tree set to be selected (Block 305). In the standardized embodiment, it is possible to select paths for multiple ECT sets as the result of a single all pairs computation as there is no element of feedback used in the computation. After the paths are selected they are stored in the forwarding database or utilized to update the forwarding database, such that all the network element pairs have at least one path between them selected.

After the shortest path is selected, a check is made to determine whether all of the network element pairs have had a path selected (Block 307). If further network element pairs have not had a path or set of paths selected, then the process continues by selecting the next network element pair to process (Block 309). If all of the network element pairs have had a shortest path selected, then if the network has been configured to use more ECT sets than have been computed to this point (Block 308), the process continues to a subsequent pass or iteration.

The link available bandwidth value for each link is calculated either as a consequence of or after the update of the forwarding database for all network element pairs has completed (Block 310). As an intermediate step the link bandwidth utilization value is calculated for each link in the network. The link bandwidth utilization value provides an indication of the level of usage based on the CIR and EIR of the I-SID endpoints attached to the network and enables the indirect identification of potential bottlenecks in the network that should be avoided if additional paths are to be formed. The link available bandwidth value is the difference between the physical capacity of a link and the link bandwidth utilization value. The link available bandwidth value can be used for bandwidth aware path selection.

FIG. 3B is a flow chart of one embodiment of the process for determining the link bandwidth utilization values. In one embodiment, the process iterates through each link in the network to determine the link utilization value for each link based on the ECTs determined up to this point in time. A check is made to determine whether all of the links in the network have been processed (Block 351). Once all of the links have been processed and their associated link available bandwidth values determined, the process can exit and return to the overall load balancing and path selection process described starting at step 311 in FIG. 3A.

If all of the links have not been processed, then the next link is selected for the determination of its link utilization value as well as its link available bandwidth (Block 353). The links can be processed in any order, serially, in parallel or in any similar method. As each link is processed a starting link utilization value is initialized (e.g., by setting the link utilization value to zero) (Block 355).

A check is then made whether all of the ECT sets computed so far have been processed relative to this link (Block 357). In other words, have all of the paths that have already been determined in the earlier pass using the common algorithm or prior passes of this process been processed for their effect on the current bandwidth aware computation. If all of the ECTs have been processed relative to the selected link, then the process continues on to the next link by returning to the processed link check (Block 351) after a link available bandwidth calculation discussed further below (Block 373). Where all of the ECT sets have not been processed the next ECT is selected.

A check is made whether all of the network element pairs (i.e., the node pairs) that have a load or are associated with a service instance (e.g., an I-SID) have been processed relative to the current ECT and link (Block 361). If all of the relevant network element pairs have been processed, then the process continues on the next ECT by returning to the processed ECT check (Block 357). If all of the relevant network element pairs have not processed then the next network element pair is selected. The relevant network element pairs can be processed in any order, serially, in parallel or in any similar method.

A check is made whether the link is on the assigned path between the current network element pair in the current ECT set (Block 365). If the link is not on the path between the network element pair in the ECT set, then the process continues on to select the next relevant network element pair by checking whether any remain to be processed (Block 361). If the link is on the assigned path between the network pair in the current ECT set, then a check is made whether all of the I-SIDs assigned to the current ECT set that are common to both network elements have been processed (Block 367). If all of the I-SIDs for the network element pair have not been considered, then the next shared I-SID is selected (Block 369). The I-SIDs in common can be processed in any order, serially, in parallel or in any similar method. The bandwidth assigned to the I-SID (e.g., the CIR associated with the I-SID) is adjusted to reflect the potential multipoint aspects of the service before applying it to the link. This is accomplished in one embodiment by dividing the bandwidth by the number of endpoints for the I-SID minus one to determine approximate link utilization expected for that I-SID. This is added to any accumulated value for the link to continue an accumulation of the total link utilization value (Block 371).

When all of the I-SIDs shared by the network element pair have been processed, the process continues to select the network element pair (Block 361). Where all the ECTs for the link have been processed, a calculation of the link available bandwidth value can be made (Block 373). The link available bandwidth is calculated by subtracting the link utilization value from the link capacity. In some embodiments, the link capacity is the total physical capacity of a link, in other embodiments, the link capacity can be an allotted or provisioned capacity (e.g., an allot capacity for a traffic type or similar classification).

When all links have been processed and the associated link utilization values and link available bandwidth determined, then the process exits and returns to the load distribution process of FIG. 3A at block 311.

With the link available bandwidth calculated, the process returns to that described in relation to FIG. 3A. For subsequent generation of ECT sets, when a set of candidate paths has been established, path selection is initially performed by generating path identifiers using the available bandwidth values to form a path identifier for each path by sorting the link available values from lowest to highest, then concatenating them together, padding the identifiers for all members in the set of qualified paths to be of equal length by appending one or more maximum link availability values, and ranking them from lowest to highest to identify paths with the best maximum e2e bandwidth and if a single path is not thereby identified and selected, and finally taking the subset of paths with equal bandwidth availability, selecting the path with the lowest sum of metrics, and if a tie still exists applying the common algorithm to the remaining tied paths to produce a unique selection.

The all network element pairs process begins again by selecting a network element pair (Block 311) and determining a set of candidate paths between the node pairs (Block 312). This process includes analyzing the set of candidate highest bandwidth paths by constructing a path identifier for each candidate shortest path. The path ID can be constructed from the link available bandwidth values for each link in a candidate shortest path, which is then lexicographically sorted from lowest value to highest value and padded by appending a maximum bandwidth value to make all candidate shortest path identifiers the same length (i.e., having the same number of values (Block 313). For example, if there is a two-hop candidate path it may have a path ID of 5-10, where 5 and 10 are the available bandwidth for the two links it traverses. A second candidate path may have five hops with a path ID of 5-10-10-15-15. To make these path IDs of equal length the first path ID is padded to generation the path ID 5-10-MAX-MAX-MAX, where ‘MAX’ is a define maximum bandwidth value usually selected to ensure the algorithm will select shorter paths. The path available bandwidth values are sorted to represent the end to end (e2e) bandwidth availability of each path, with the minimum bandwidth link at the beginning of the path ID and the maximum bandwidth link at the end of the path ID. The path ID of each candidate shortest path is ranked by their constituent path available bandwidth values (Block 315). In the above example, the 5-10-MAX-MAX-MAX path ID would be ranked above the 5-10-10-15-15-15 path ID, because the first two positions are equal (5-10), but the third position differentiates the two where ‘MAX’ is greater than 10. In another embodiment, instead of padding with MAX values the ranking comparison can simply end in the comparison of paths during the ranking by selecting the shorter path of the set that had been equal to that point in the comparison.

This overall process set forth in FIG. 3A always produce a unique path choice. The result is independent of any direction of computing: This is achieved by sorting the link available bandwidth values prior to ranking and intermediate state properties. The path selection algorithm produces the same result independent of the order of computation. The reverse path also selects paths identically to the forward path so the order of operations of any intermediate path selection do not matter. The path selection can incrementally resolve ties such the intermediate state maintained as the Dyjkstra algorithm expands can be minimized. This also can be expressed as any portion of the selected path is also congruent with the selected path.

A check is made to determine whether there is more than one highest ranked candidate path based on each path ID for a given network element pair (Block 317).

Where a uniquely highest ranked path ID exists it can be selected without further processing and the forwarding database can then be updated with this selected path (Block 318). When there is more than one equal path ID for a candidate highest bandwidth path (i.e., identical path IDs), then if one of the tied paths has a unique lowest metric it can be selection, else all paths with equal path ID and lowest metric are processed using the common algorithm tie-breaking process to perform path selection in this subset of highest ranked candidate paths (Block 321). The forwarding database is then updated to reflect the selected paths (Block 318).

In other embodiments, it is possible to use a schedule of variations of the common algorithm or another algorithm guaranteed to produce a unique result of the appropriate properties. For example, the 802.1aq algorithm defines 16 variations, and the secondary tie breaker for the second set could be algorithm variant 2 (algorithm ID 0x08c202), for the third set variant 3 (algorithm ID 0x08c203) or similar configuration.

A check is then made to determine whether all of the network element pairs have a selected shortest path or set of shortest paths (Block 319). If not, then the process continues by selecting the next network element pair to process (Block 323). If all of the node pairs have been processed, then a check is made to determine whether additional paths or ECT sets are needed (Block 325). If no additional paths or ECT sets are needed (this may be a parameter that is set by a network administrator or similarly determined, e.g., this parameter can be preconfigured and is common network wide, for at least 802.1aq, all nodes agree on the number of ECT sets and the algorithms as part of the hello handshake procedure), then the load distribution process ends. If additional paths or ECT sets are needed, then the process continues with a third pass or iteration that is similar to the second, but builds on the cumulative link bandwidth utilization determined in previous iterations. This process can have any number of iterations and is only limited by the particular networking technology in use (e.g. Ethernet would cap out at 4094 iterations since the process would exhaust the set of possible B-VIDs as ECT set IDs).

This process provides advantages in load distribution over the previous implementations. It does not consider all network edge devices to offer equal load to all peers, but actually models the placement of the traffic for individual service instances. Where there is a unique highest ranked path in the bandwidth aware computation, it is the path with the highest minimum e2e bandwidth value or it is tied for minimum, but has the highest overall available bandwidths as every sub fragment of path had the highest available e2e bandwidth and was greater than or equal to the next highest ranked path. Padding the path IDs with MAX simply means if there is a tie up to the number of hops in the shortest path, and the tie is with a longer path, the shorter path hop wise will be preferred. The process also ensures that paths with superior sub-fragments are selected. If the sub-fragments of the path had inferior capacity it would be detrimental in building a multipoint network where as much capacity as can be obtained in any sub fragment is desired. Overall, the generation of subsequent shortest path tree sets using the bandwidth aware computation reduces the coefficient of variation of link load across the entire network.

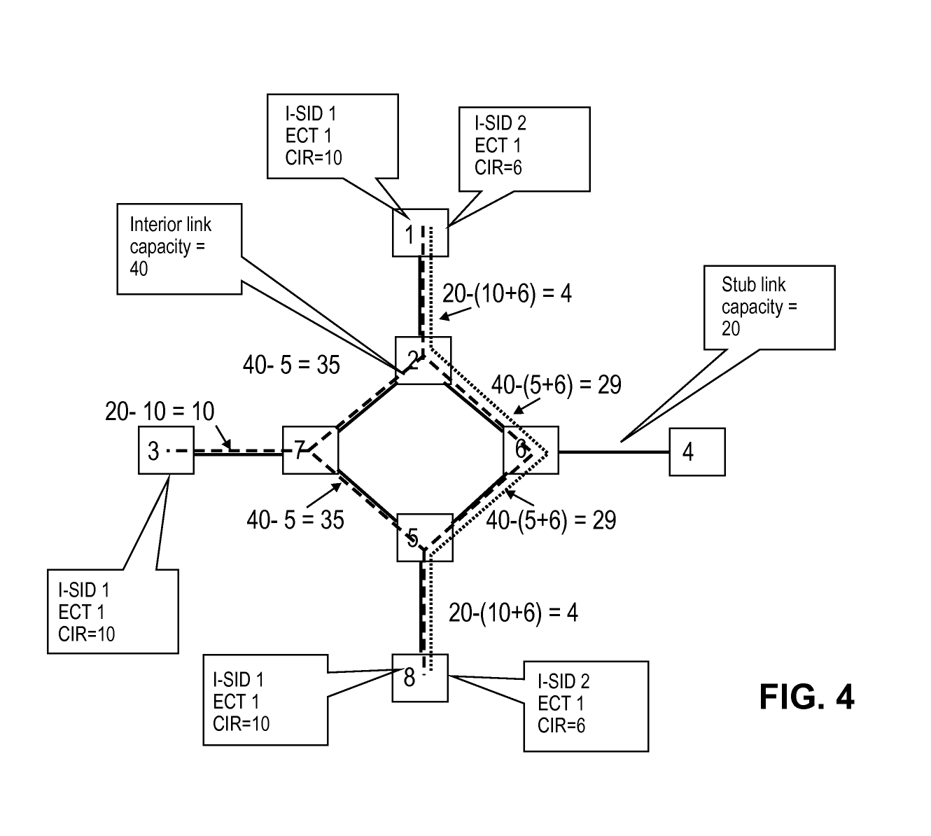

FIG. 4 is a diagram of an example of a multi-point to multi-point network topology. The diagram illustrates the calculation of link bandwidth utilization values for each link in this network topology. The results of the topology aware computations are input into the bandwidth aware computation to determine the link bandwidth utilization. The boxes at each endpoint correspond to the dotted line paths of each I-SID. In this example there is one multiple endpoint I-SID and one point to point (P2P) I-SID attached to the network I-SID 1 and I-SID 2. A first ECT 1 is computed for each using the normal common algorithm in a topology aware computation. In the p2p I-SID 2, the CIR is a consistent 6 over its entire path (the dotted line). In the multiple endpoint I-SID 1 (dashed line) the CIR of 10 is divided evenly. In other embodiments, the CIR can be divided unevenly based on any criteria.

In the illustrated equations on each link, the far left number is the physical link capacity, the next number (where applicable) is I-SID 1 bandwidth utilization and the third number is the bandwidth utilization of I-SID 2, where the combined link bandwidth utilization of the two I-SIDS is subtracted from the physical link capacity to get the result on the far right, which is the link free capacity or link bandwidth utilization value. In the example, the spoke or stub link capacity is 20 (an example value using any given units of measurement such as mega-bits or giga-bits a minute or second) and the hub or interior link capacity is 40 units per link.

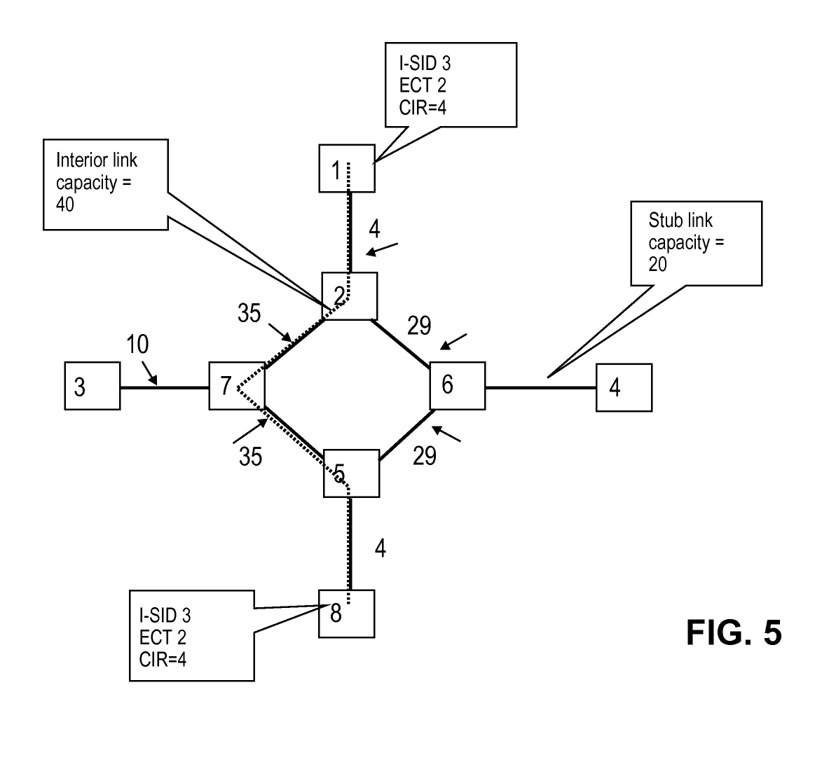

FIG. 5 is a diagram of another example of a multi-point to multi-point network topology. In this example, on a second pass of the network after the bandwidth allotment of FIG. 4 to place a third I-SID 3, which is a p2p from node 1 to node 8, the same as I-SID 2, the bandwidth utilization values from the first pass are shown. On this second pass, the 1-2-7-5-8 path has a path ID of 4-4-35-35, while the alternate path 1-2-6-5-8 has a path ID of 4-4-29-29. Thus, the first path is chosen for the I-SID 3 using the bandwidth aware computation for path selection.

It can be noticed, that after I-SID 3 is placed, the links 1-2 and 5-8 are at full capacity. In one embodiment, if additional I-SIDs required more capacity than was available the process would ignore the full capacity limitation in path selection as this would be considered a separate network planning issue.

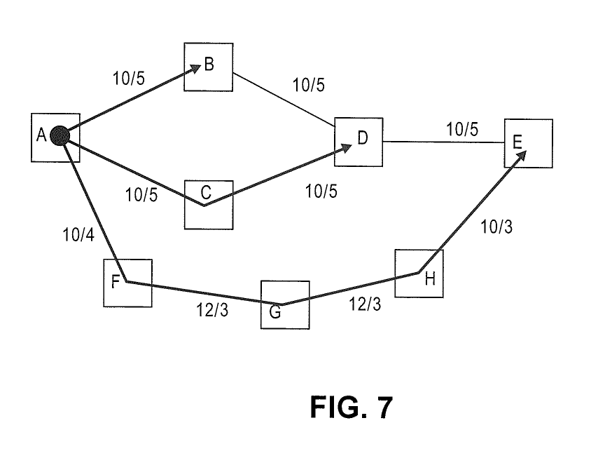

FIG. 7 is a diagram of one example embodiment applying the bandwidth aware computation to an example topology. The illustrated example shows an example topology and shortest paths calculated from node A to each other node in the network. The left-hand number on each link is the link available bandwidth and the right-hand number is the metric for the link. Thus, on link A-B the link available bandwidth is 10 and the metric is 3.

In the example, possible loop free candidate paths from node A to node E include ABDE, ACDE and AFGHE. For this example it is assumed that the path AFGHE has the lowest or is tied for the lowest metric with at least one of the other two paths. Assuming the service from A to E is being added after the topology aware computation, these alternate paths are analyzed based on their path IDs, which are formed from their constituent link available bandwidth. In this case, ABDE has a path ID of 10-10-10-MAX, ACDE has a path ID of 10-10-10-MAX and AFGHE has a path ID of 10-10-12-12. AFGHE is chosen over the other two candidate paths, because the third position value of the path ID for AFGHE (12) is greater than the third position value of the other paths. Thus, a longer and higher metric path is selected in this case. If only the ABDE and ACDE path had been available or had been highest ranked, then the common algorithm would have been utilized to select between them since they have identical path IDs.

Variations and Features

1) In some embodiments, the load distribution process and system also enables an administrator to “pre-bias” a link with a load factor which will have the effect of shifting some load away from the particular link. This permits subtler gradations for manipulating routing behavior than simple metric modification, much simpler administration than multi-topology routing, and obviates the need for link virtualization (such as MPLS “forwarding adjacencies” as per RFC 4206) to artificially drive up the mesh density, which is done in prior routed networks. For the two stage sort, the timing of when the link bias is applied matters. It is typically only considered for the second and subsequent iterations. In an implementation where it is utilized in the first iteration, all equal cost paths can be tied for utilization, applying the bias factor immediately would tend to shift all load away from that link with the bias toward the other paths resulting from the first iteration or subsequent iterations depending on the size of the bias.

2) The traffic descriptor used to provide the bandwidth information between the network elements does not have to be the MEF10.2 mention herein above. Any means of expressing a resource requirement using any format and any protocol can be utilized to exchange the bandwidth information between the network elements (e.g., the CIR and/or the EIR).

3) The formula for dividing bandwidth by the number of endpoints does not necessarily need to match the one expressed above and described in relation to FIG. 3B. Any formula can be utilized, including keeping it linear and simply incorporating a dilation factor. The formula could be non-linear where the multiplier diminished in proportion to the number of endpoints that transited a single link.

4) The bandwidth utilization does not need to be based on CIR alone. The bandwidth aware computations can utilize CIR plus some adjusted EIR value or any other bandwidth metric or utilization information.

5) The available bandwidth number does not need to be based on 100% of the physical capacity. For example, in some networks, only a portion of bandwidth is allocated for a given traffic type (say 60% of a link is maximum total CIR value). Thus, the link free capacity can be calculated on different base numbers.

6) A network converging on >100% utilization of the maximum allowable bandwidth utilization on a link could be an alarmable event and an input to capacity planning, it could also be correlated with actual bandwidth utilization and load distribution.

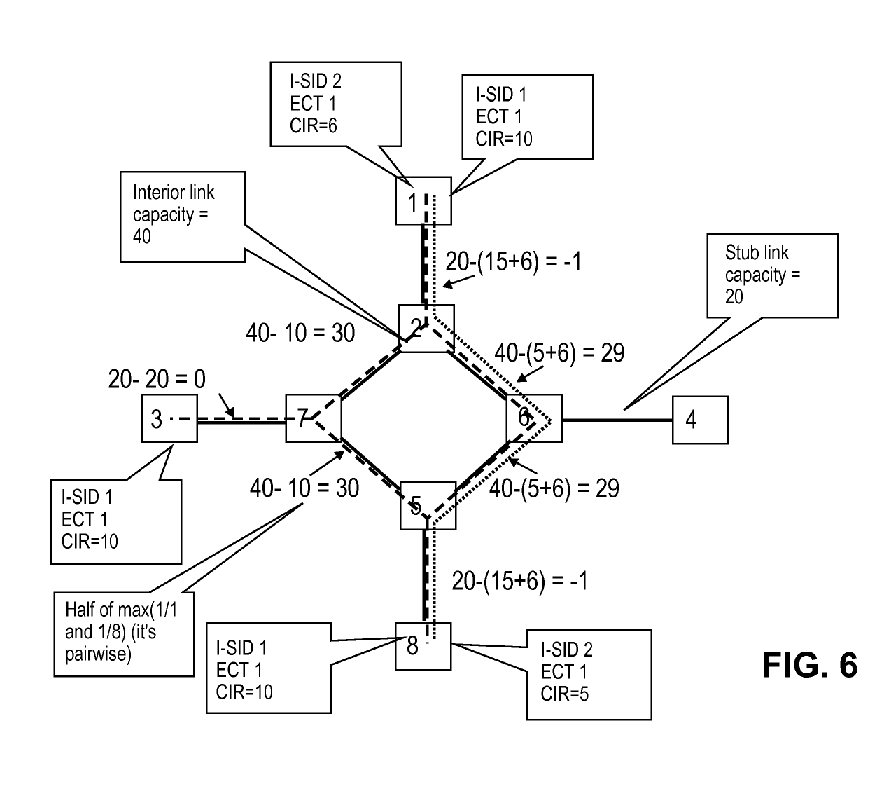

7) The load distribution process has been applied herein above to symmetric paths and the examples show all I-SID endpoints having common values in the traffic descriptor. Asymmetric values can also be supported, in which case the link utilization would be based on taking the maximum value of the set of values for the I-SID that transited the link after adjusting for the number of served endpoints. Further, for non-Ethernet technologies and network architectures that permit asymmetric paths, it would be possible to use a descriptor and sum in each direction. FIG. 6 is a diagram of a further example of an asymmetric multi-point to multi-point network topology. This example returns to the stage of path selection shown if FIG. 4. In this example, demonstrating an asymmetric variation, I-SID 1 at node 3 has a larger descriptor (i.e., a larger bandwidth requirement of CIR 20, instead of CIR 10 at the other endpoint nodes 1 and 8). Thus, links that are transited by traffic from endpoint node 3 (e.g., 1-2, 2-7, 3-7, 5-7 and 5-8) carry the I-SID node 3 load and receive its descriptor. The nodes transited by this heavier load take this into account, while nodes that are not transited by this heavier traffic only account for the CIR 10 of the other I-SID endpoints. The diagram illustrates the link bandwidth utilization values in this scenario.

8) Packet networks have a notion of required queuing discipline or priority encoded in packets, for example internet protocol differentiated service code point (IP DSCP) or Ethernet P-bits. In some embodiments, traffic descriptors can be provided per DSCP or P-bit. In these cases, it is not possible to route individual P-bit or DSCP marked flows separately. However, the embodiments encompass variations of the amount of bandwidth profile information that is flooded in the routing system and considered when selecting paths.

9) Changing bandwidth settings for an I-SID that is not associated with the initial ECT set computation may be hitful for multicast, but will not be hitful for unicast. In some embodiments, all non-multicast service instances (e.g. p2p or ELINE) can be associated with bandwidth aware ECT set computations as adds/moves and changes for this class of service would gracefully and hitlessly adapt to service topology changes. When manipulating equal cost paths, enhanced filtering can be employed such that there is never reason to discard frames rerouted as a result of a service change. I-SIDs that used edge replication instead of network based replication could also safely be mapped to bandwidth aware ECT sets.

10) The link available bandwidth number could be rounded or truncated to the effect that trivial changes did not impact network forwarding, and/or the possibilities of tied paths could be increased when generating multiple ECT sets from each iteration of bandwidth aware path selection.

Thus, a method, system and apparatus for load distribution in a network that takes into account link bandwidth utilization has been described. It is to be understood that the above description is intended to be illustrative and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method in a network element for improved load distribution in a network that includes the network element, wherein the network element is one of a plurality of network elements in the network each of which implement a common algorithm tie-breaking process as part of a computation used to produce minimum cost shortest path trees, the network element includes a database to store the topology of the network, a set of service attachment points is mapped to network elements in the topology for services individually associated with an equal cost tree (ECT) set and associated with per service bandwidth requirements, wherein the topology of the network includes a plurality of network elements and links between the network elements, the method to generate multiple ECT tree sets for connectivity establishment and maintenance of the connectivity in the network, the method defining a bandwidth aware path selection, the method reduces the coefficient of variation of link load across the entire network, the method comprising the steps of:
determining a set of equal cost shortest paths between each network element pair based upon the topology of the network;
checking whether a tie exists between multiple equal cost shortest paths from the set of equal cost shortest paths;
applying the common algorithm tie-breaking process where the tie exists between multiple equal costs shortest paths;
determining a link bandwidth utilization value and a link available bandwidth value for each link of the network;
selecting a network element pair associated with an ECT to be added to the network that have attachment points to a common service instance that has been assigned to that ECT set;
determining a set of candidate paths between the network element pair;
generating a path identifier for each candidate path, where the path identifier is constructed from link available bandwidth values lexicographically sorted from lowest value to highest value;
ranking candidate shortest paths by link available bandwidth of path identifier;
checking whether a tie exists between highest ranked candidate paths by path identifiers;
storing a highest ranked candidate path by path identifier in the forwarding database where no tie exists between highest ranked candidate paths by path identifiers; and
applying the common algorithm tie breaking process to highest ranked candidate paths by path identifier where the tie exists between highest ranked candidate paths by path identifiers.

2. The method of claim 1, further comprising the step of:
padding the path identifiers of each candidate path to have an equal length with other candidate paths by appending one or more maximum bandwidth values.

3. The method of claim 1, wherein determining the link bandwidth utilization value and the link available bandwidth value for each link of the network further comprises the step of:
adding a service identifier registration (I-SID) bandwidth divided by a number of endpoints of the I-SID minus one to a link utilization value.

4. The method of claim 3, wherein determining the link bandwidth utilization value and the link available bandwidth value for each link of the network further comprises the step of:
calculating the link available bandwidth value by subtracting the link utilization value from a link capacity.

5. The method of claim 1, wherein determining the link bandwidth utilization value and the link available bandwidth value for each link of the network processes all network pairs that are a source of load for a selected equal cost tree.

6. The method of claim 1, wherein checking whether a tie exists between highest ranked candidate paths by path identifiers, further comprises the steps of:
selecting a path with a lowest metric, if multiple candidate paths are tied for highest ranking by path identifiers; and
applying the common algorithm to determine a path, if multiple candidate paths are tied for highest ranking by path identifiers and lowest metric.

7. A network element for improved load distribution in a network that includes the network element, wherein the network element is one of a plurality of network elements in the network each of which implement a common algorithm tie-breaking process as part of a computation used to produce minimum cost shortest path trees, wherein a topology of the network includes a plurality of network elements and links between the network elements, the method defining a bandwidth aware path selection, the network element implementing a method reduces the coefficient of variation of link load across the entire network, the network element comprising:
a topology database is configured to store link information for each link in the network, a set of service attachment points is mapped to network elements in the topology for services individually associated with an equal cost tree (ECT) set and associated with per service bandwidth requirements;
a forwarding database is configured to store forwarding information for each port of the network element, wherein the forwarding database indicates where to forward traffic incoming to the network element; and
a control processor coupled to the topology database and the forwarding database, the control processor configured to process data traffic, wherein the control processor executes a shortest path search module, a sorting module, and a load distribution module,
the shortest path search module configured to determine a set of equal cost shortest paths between each network element pair using the topology of the network wherein the shortest path search module is configured to determine a set of candidate paths between each of the network element pairs and to send the set of equal cost shortest paths to the sorting module,
the sorting module configured to generate a path identifier for each candidate path, where the path identifier is constructed from link available bandwidth values lexicographically sorted from lowest value to highest value and to send the path identifier for each candidate path to the load distribution module, and
the load distribution module configured to rank each of the set of candidate paths based on the path identifiers, to check whether a tie exists between highest ranked candidate paths by path identifiers, to store a highest ranked candidate path by path identifier in the forwarding database where no tie exists between highest ranked candidate paths by path identifiers, and to apply the common algorithm tie breaking process to highest ranked candidate paths by path identifier where the tie exists between highest ranked candidate paths by path identifiers.

8. The network element of claim 7, wherein the load distribution module is further configured to pad the path identifiers of each candidate path to have an equal length with other candidate paths by appending one or more maximum bandwidth values.

9. The network element of claim 7, wherein the load distribution module is further configured to determine the link bandwidth utilization value and the link available bandwidth value for each link of the network by adding a service identifier registration (I-SID) bandwidth divided by a number of endpoints of the I-SID minus one to a link utilization value for each node pair with interest in that I-SID whose connectivity transits the link.

10. The network element of claim 9, wherein the load distribution module is further configured to determine the link bandwidth utilization value and the link available bandwidth value for each link of the network by calculating the link available bandwidth value by subtracting the link utilization value from a link capacity.

11. The network element of claim 7, wherein the load distribution module is further configured to determine the link bandwidth utilization value and the link available bandwidth value for each link of the network by processing all network pairs that are a source of load for a selected equal cost tree.

12. The network element of claim 7, wherein the load distribution module is configured to check whether a tie exists between highest ranked candidate paths by path identifiers, where the load distribution module is further configured to select a path with a lowest metric, if multiple candidate paths are tied for highest ranking by path identifiers, and configured to apply the common algorithm to determine a path, if multiple candidate paths are tied for highest ranking by path identifiers and lowest metric.
